(19) United States
(12) Patent Application Publication
(10) Pub. No.: US 2005/0114319 A1
(43) Pub. Date: May 26, 2005

(54) System and method for checking a content site for efficacy

(75) Inventors: Andrew Brent, Waltham, MA (US); Timothy H. Eshelman, Arlington, MA (US); Craig Fifield, Nashua, NH (US); Debra M. Reich, Watertown, MA (US); James L. Silvestri, Beverly, MA (US)

Correspondence Address: Joseph R. Kelly;WESTMAN CHAMPLIN & KELLY, Suite 1600 - International Centre, 900 Second Avenue South, Minneapolis, MN, 55402-3319, US

(73) Assignee: Microsoft Corporation, Redmond, WA (US)

(21) Appl. No.: 10/796,701

(22) Filed: Mar. 9, 2004

Related U.S. Application Data
(60) Provisional application No. 60/524,329, filed on Nov. 21, 2003.

(51) Int. Cl. G06F 17/30

(52) U.S. Cl. 707/3

(57) ABSTRACT

The present invention provides a system and method for automatically suggesting optimizations that can be made to content pages to increase the chances that the network site containing the content page will be indexed and returned high in the rank ordered list of results form a search engine. In one embodiment, the present invention also includes a keyword generation tool for use in generating effective keywords for which a content page can be optimized.

### BACKGROUND OF THE INVENTION

The present invention deals with generating content, accessible over a network such as a web. More specifically, the present invention deals with verifying the effectiveness of web content so that the chances of a web site being presented first by a search engine in response to a keyword search is increased.

In order for a business, or content provider, to have network information available and searchable by a network search engine, the business or content provider generally submits its content for indexing by the search engine. The indexing process is conventional and well known.

Conventional search engines use a tool referred to as a spider, or crawler. The crawler accesses sites on a computer network (which may be a global computer network such as the Internet or World Wide Web) and generates lists of words that are found on those sites. The crawler also follows each link on the site it is currently crawling. Based on the words and links, the web crawler creates an index of the words associated with the uniform resource locator (URL) of the site on which the crawler found the words.

When the search engine is used by a user attempting to locate information on the network, the user typically types in one or more keywords that form the basis of a search. The search engine then searches its index based on the keywords entered by the user and returns a list of web sites related to those keywords. By performing certain commonly known indexing and analysis techniques, the conventional search engine will generally rank order the list of web sites based on how closely they are believed to be related to the keywords entered by the user.

Of course, the content provider or business typically wants its web site to be listed first in results returned by the search engine when relevant keywords are entered. There have been some attempts to arrange content on web pages in such a way as to optimize the web pages for searching (i.e., to increase the chance that the content provider's web site will be returned in a relatively high position in the rank ordered search results).

### SUMMARY OF THE INVENTION

The present invention provides a system and method for automatically suggesting optimizations that can be made to content pages to increase the chances that a network site containing the content page will be indexed and returned high in the rank ordered list of results from a search engine. In one embodiment, the present invention also includes a keyword generation tool for use in generating effective keywords for which a content page can be optimized.

In accordance with another embodiment, the present invention uses hierarchical rules that apply in determining the effectiveness of a web site. The hierarchical rules can be configured to apply differently based on how important the keyword is to a network site.

### BRIEF DESCRIPTION OF THE DRAWINGS

FIG. 1 is a block diagram of one illustrative embodiment of an environment in which the present invention can be used.

FIG. 2 is a block diagram of one illustrative embodiment of a network content processing system in accordance with the present invention.

FIG. 3 is a flow diagram illustrating the operations of the system shown in FIG. 2, in accordance with one illustrative embodiment of the present invention.

FIG. 4 is a flow diagram illustrating the operation of a keyword selection tool in accordance with one embodiment of the present invention.

FIGS. 5A-5F are screen shots further illustrating the operation of a keyword selection tool in accordance with one embodiment of the present invention.

FIG. 6 is a screen shot illustrating an overview report generated by the system shown in FIG. 2, in accordance with one embodiment of the present invention.

FIGS. 7A-7C are screen shots illustrating a broken links report generated by the system shown in FIG. 2, in accordance with one embodiment of the present invention.

FIGS. 8A-8B are screen shots illustrating an incoming links report generated by the system shown in FIG. 2, in accordance with one embodiment of the present invention.

FIG. 9 is a screen shot illustrating a link download time report generated by the system shown in FIG. 2, in accordance with one embodiment of the present invention.

FIGS. 10A-10B are screen shots illustrating a readiness check generated by the system shown in FIG. 2, in accordance with one embodiment of the present invention.

Appendix A is one illustrative list of messages that indicate rules applied in checking content pages for readiness.

### DETAILED DESCRIPTION OF ILLUSTRATIVE EMBODIMENTS

The present invention deals with generating content pages that will be accessible through a search engine over a computer network. More specifically, the present invention deals with a system that checks to determine whether content pages are configured in a proper way to increase the chances that they will be indexed and returned by a search engine in response to a keyword search. The present invention can be used to examine content in a network environment or in a standalone environment. However, before describing the present invention in greater detail, one illustrative embodiment of an environment in which the present invention can be used is discussed.

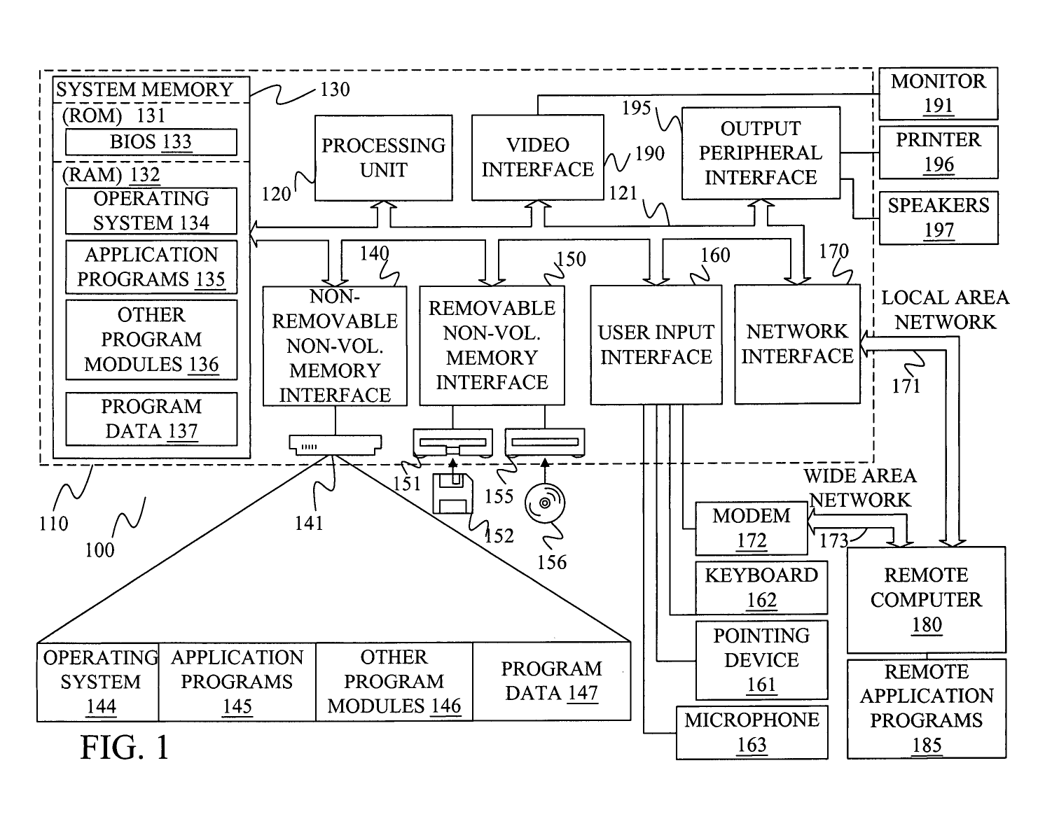

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It will be understood that the present discussion may proceed with respect to a global computer network (such as the Internet or World Wide Web). However, the present invention is not so limited but could be used on any searchable network, and the discussion herein is exemplary only.

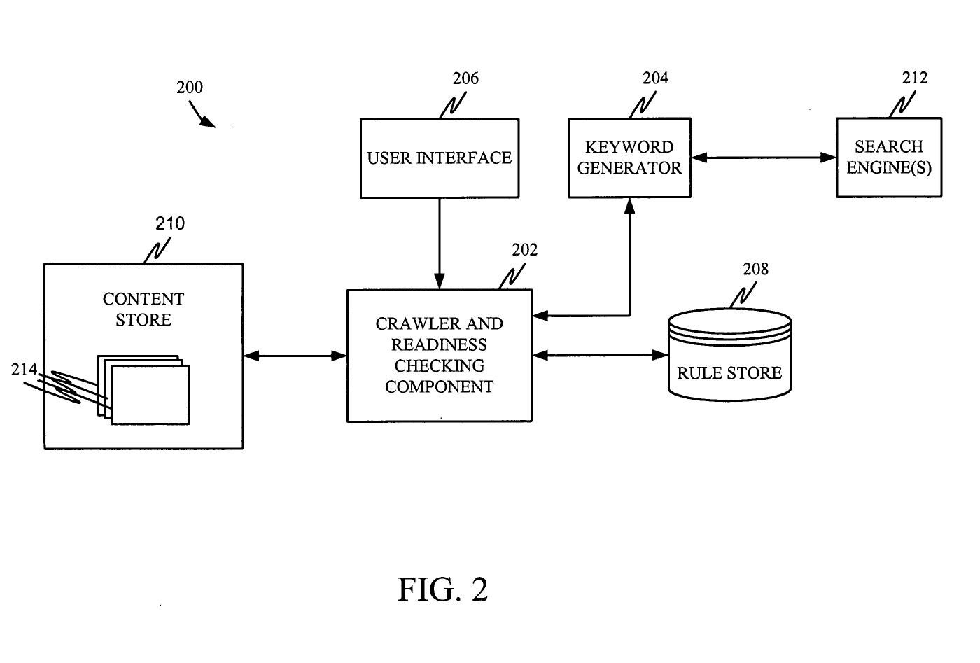

FIG. 2 is a block diagram of a web content processing system 200 in accordance with one embodiment of the present invention. System 200 includes crawler and readiness checking component 202, keyword generator 204, user interface 206, and rule store 208. System 200 is also shown connected to a content store 210 and to one or more search engines 212.

In one illustrative embodiment, system 200 is configured to crawl through the entire site represented by content store 210 based on a keyword phrase entered by the user. Then user is shown all pages that are ready for submission to a search engine for indexing. The user can select pages for optimization as well. In optimizing a page, system 200 is configured to access web pages or content pages 214 in content store 210 and determine whether they are written and laid out in a manner which is likely to increase the possibility that they will be returned at a relatively high position in the rank ordered list of web sites returned by conventional search engines in response to user queries.

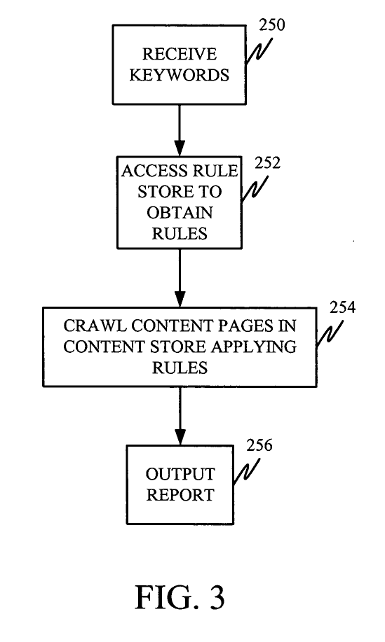

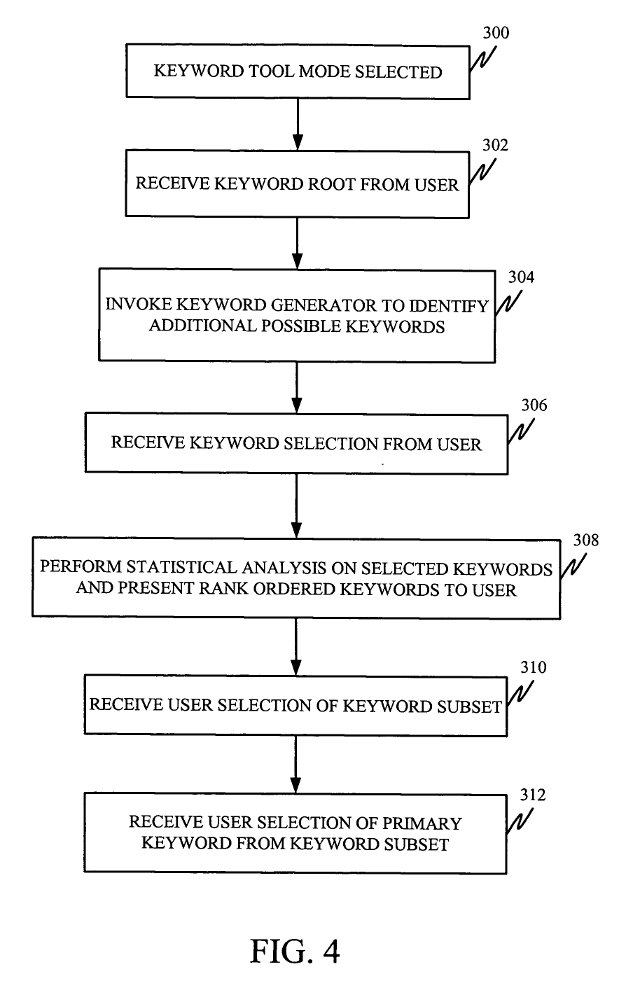

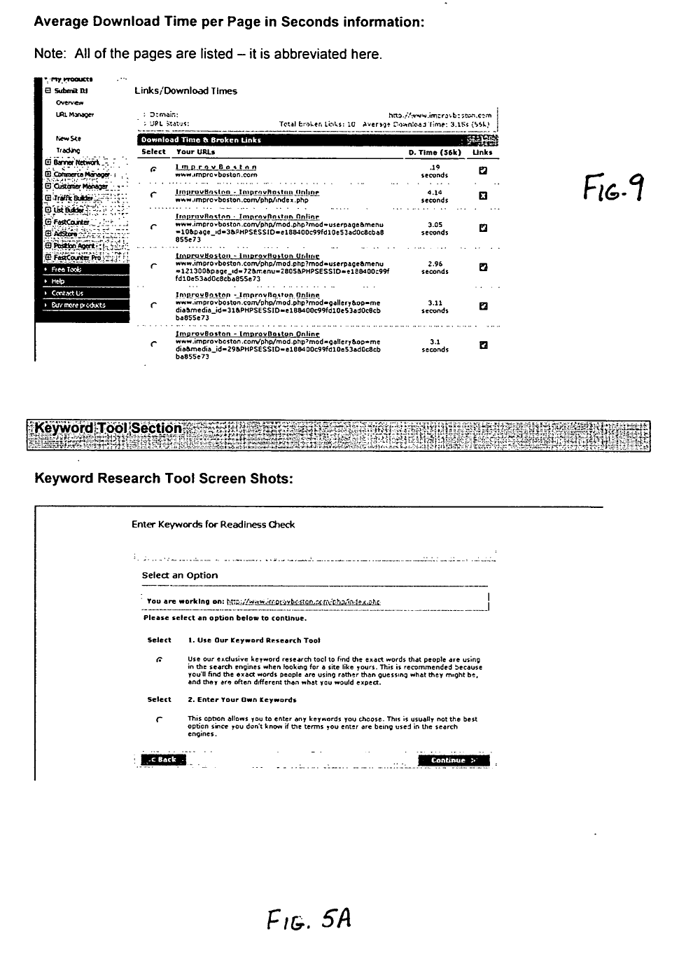

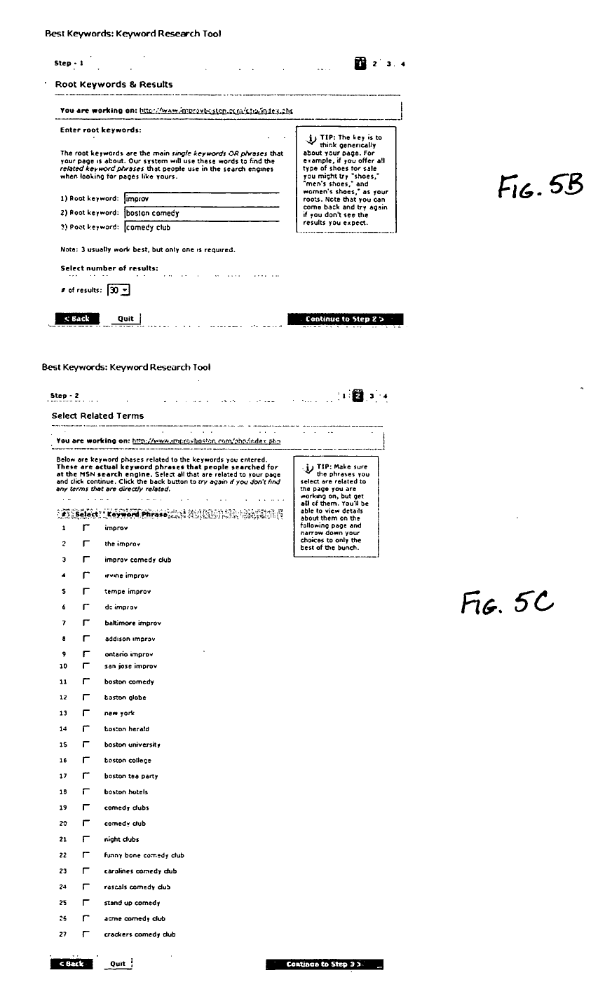

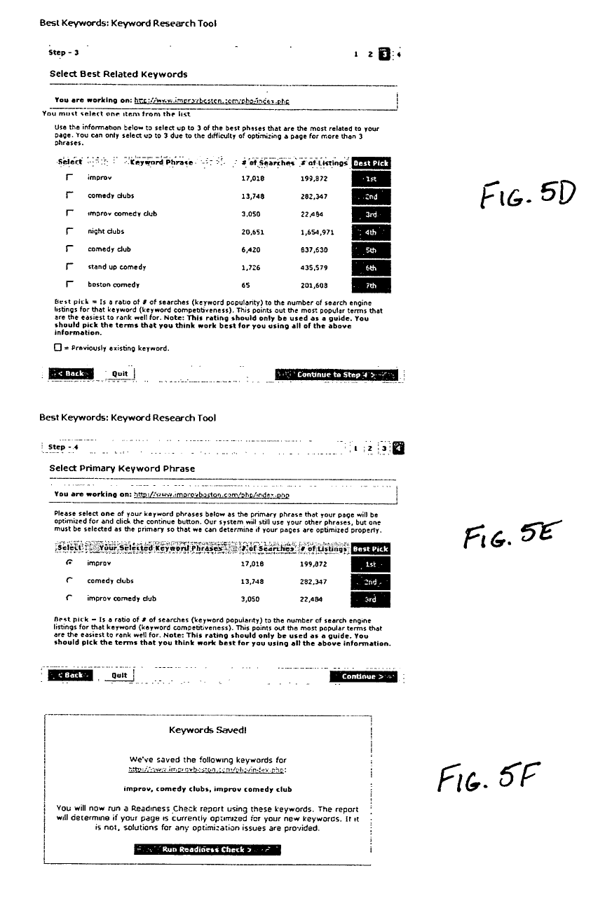

This operation of system 200 is illustrated by the flow diagram shown in FIG. 3. First, crawler and readiness checker component 202 (component 202) receives keywords based on a user input. This is illustrated by block 250 in FIG. 3. The keywords can simply be manually entered by a user through user interface 206. Alternatively, the user can invoke keyword generator 204 which automatically generates possible keywords for selection by the user. The operation of keyword generator 204 is discussed in greater detail below, with respect to FIGS. 4 and 5A-5F. Suffice it to say, for the present discussion that component 202 receives keywords.

Once the keywords are received, component 202 accesses rules in rule store 208. This is indicated by block 252 in FIG. 3. The rules are used by component 202, (some in conjunction with the keywords entered) in scrutinizing the content pages 214 in content store 210 to determine whether the content in content store 210 is written and laid out in an efficient manner for ready indexing and return by a conventional search engine. Some of the rules are described in greater detail below. However, for the sake of example, the rules can include such things as whether a keyword is found within a title tag on pages 214, whether meta tags exist for the keywords, whether the uniform resource locator (URL) redirects the crawler to an unreachable URL, whether the URL is formatted properly, etc.

The crawler in component 202 crawls through the content and formatting on the pages 214 in content store 210, applying the rules from rule store 208 to determine whether the content or formatting complies with, or violates, any of the rules being applied. Crawling the content pages and applying the rules is indicated by block 254 in FIG. 3.

Component 202 then outputs a report to the user, again illustratively through user interface 206. This is indicated by block 256 in FIG. 3. The reports can take a wide variety of different forms, but generally indicate how effective the content pages 214 on content store 210 will be in achieving indexing and a high ranking in the rank ordered list of web sites returned by search engines when searching based on queries input by a user. A number of illustrative reports will be described below with respect to FIGS. 6-10B.

FIG. 4 is a flow diagram illustrating the operation of keyword generator 204 in greater detail. The flow diagram of FIG. 4 will be discussed in conjunction with the screen shots illustrated in FIGS. 5A-5F.

In order to determine whether keyword generator 204 will be invoked, component 202 first receives from the user through user interface 206, a selection as to the mode by which keywords will be input. One embodiment of such a screen shot is illustrated in FIG. 5A. It can be seen that the user can simply make a selection indicating that the user wishes to input her or his own keywords, or that the user wishes to use the keyword generator tool (or keyword research tool) 204. If the user wishes to enter keywords manually, a suitable screen is simply presented such that the user can enter the desired keywords. However, for the sake of example, it is assumed that the user wishes to invoke keyword generator 204, and that selection is shown on FIG. 5A. Selection of the mode by which keywords are input is indicated by block 300 in FIG. 4.

When the user has selected the mode indicating that keyword generator 204 is to be used, component 202 then receives from the user, through user interface 206, one or more root keywords which the user desires to initiate the process of keyword selection with. These root keywords are illustratively words that describe what the user's content page to be analyzed is about. One illustrative screen shot for receiving the root keywords from the user is shown in FIG. 5B. Receiving the keyword roots from the user is illustrated by block 302 in FIG. 4.

Some search engines offer information that can be used to identify alternative keywords. For instance, such search engines track the keywords used by an individual user in a given search process. These search engines can be queried for this information to locate alternative keywords. An initial keyword is input and the search engine returns additional words used by other users who also used the initial keyword in conducting a search.

Thus, keyword generator 204 accesses one or more search engines 212 to obtain a list of alternative keywords that could be used by the user in describing the content of the content store 210. Invoking the keyword generator to identify additional possible keywords is illustrated by block 304 in FIG. 4. One illustrative screen shot of a returned set of alternative keywords is illustrated in FIG. 5C.

Component 202 then requests the user to select all of the returned keywords which are applicable to, or related to, the content of the user's content page to be checked. In doing so, the user can simply select the relevant keywords on the screen shot shown in FIG. 5C. Receiving the keyword selection by the user is indicated by block 306 in FIG. 4.

Component 202 then performs statistical analysis on the selected keywords in order to determine which are most effective as search terms in uniquely identifying the content page. This can be done in a wide variety of ways. However, in one illustrative embodiment, component 202 invokes information from the records kept by search engines 212 to determine how many searches were run using each of the keywords selected, and also how many search engine results are returned based on the search using that keyword.

For instance, if a search term is used a very large number of times, and there are only a very few result listings returned for that search term, then it is determined that the search term will be quite highly effective in uniquely identifying the content page and obtaining a high ranking in the rank ordered search results. However, if a search term is not used by many searchers (i.e., if not many searches are performed using that term) but the number of search results returned using that term is relatively high, then the search term will be less effective in obtaining a high rank in a rank ordered list of search results. One embodiment of the statistical processing uses a ratio of these numbers. Based on this statistical processing, component 202 returns to the user through user interface 206 a rank ordered list of keywords. One screen shot illustrating such a rank ordered list is shown in FIG. 5D, and presenting that list is illustrated by block 308 in FIG. 4.

As the screen shot in FIG. 5D illustrates, component 202 allows the user to select up to a predetermined number of the displayed keywords for use in analyzing its content page. In the embodiment illustrated in FIG. 5D, the user is allowed to choose up to three words. Receiving a user selection of this keyword subset is illustrated by block 310 is FIG. 4.

Component 202 then displays that subset of words to the user and requests that the user select one of those keywords as the primary keyword. This is illustrated by block 310 in FIG. 4. One illustrative screen shot which allows the user to select the primary keyword is shown in FIG. 5E.

Once the keywords are selected and the primary keyword is identified, component 202 has sufficient information to perform a readiness check on the specified web page 214 in content store 210. FIG. 5F is one illustrative screen shot illustrating this.

As discussed with respect to FIG. 3, component 202 then accesses rules in rule store 208 and applies those rules to the content page 214 being examined in content store 210. The rules may illustratively be hierarchically selected. In other words, some of the rules may be more strictly applied when examining the content page 214 using the primary keyword, than when examining the content page 214 using the remaining keywords. Similarly, more rules may be applied when examining the content page 214 with respect to the primary keyword than with respect to the other keywords. In any case, crawler 202 examines the content of a given web page 214 in content store 210 applying the rules from rule store 208. The particular rules applied can take a wide variety of different forms, and can be modified based on empirical data. One illustrative embodiment of errors identified by applying the rules is set out in appendix A. Of course, it will be noted that this list of errors is illustrative only.

After examining all of the pages 214 in content store 210, component 202 provides a report to the user through user interface 206. Of course, the report can take a wide variety of different forms, but a number of different illustrative embodiments of such reports are illustrated in FIGS. 6-10B.

FIG. 6 illustrates an overview report for the entire site that contains web pages 214 based on the initial crawl through the entire site. In one illustrative embodiment, each of the pages 214 are examined separately, in a separate operation, for optimization using selected keywords. However, the overall web site containing those pages 214 is the subject of the overview report shown in FIG. 6. It can be seen that the embodiment of the overview report in FIG. 6 gives such information as the number of pages analyzed, the number of pages ready to submit (for which no changes are suggested) the number of pages needing work (for which changes and optimizations are suggested), the average download time, the number of links to the site under examination, the number of broken links (which when followed did not lead to a viable site) and the total number of mouse clicks to the submitted pages (which is illustratively shown for a page only after the page is submitted).

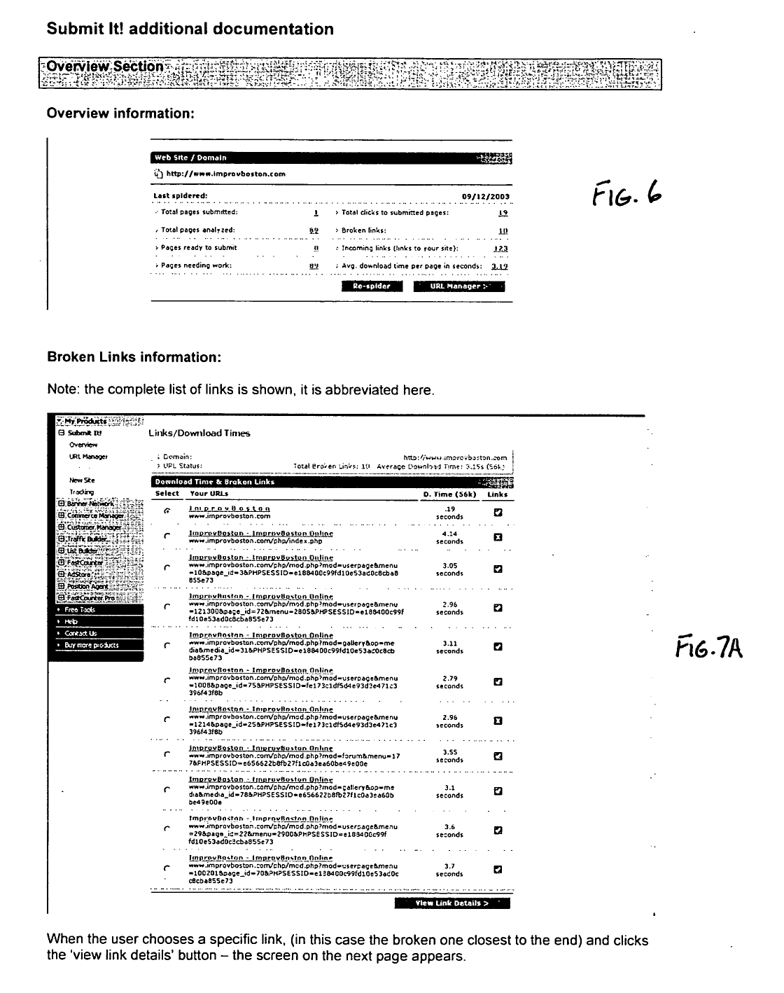

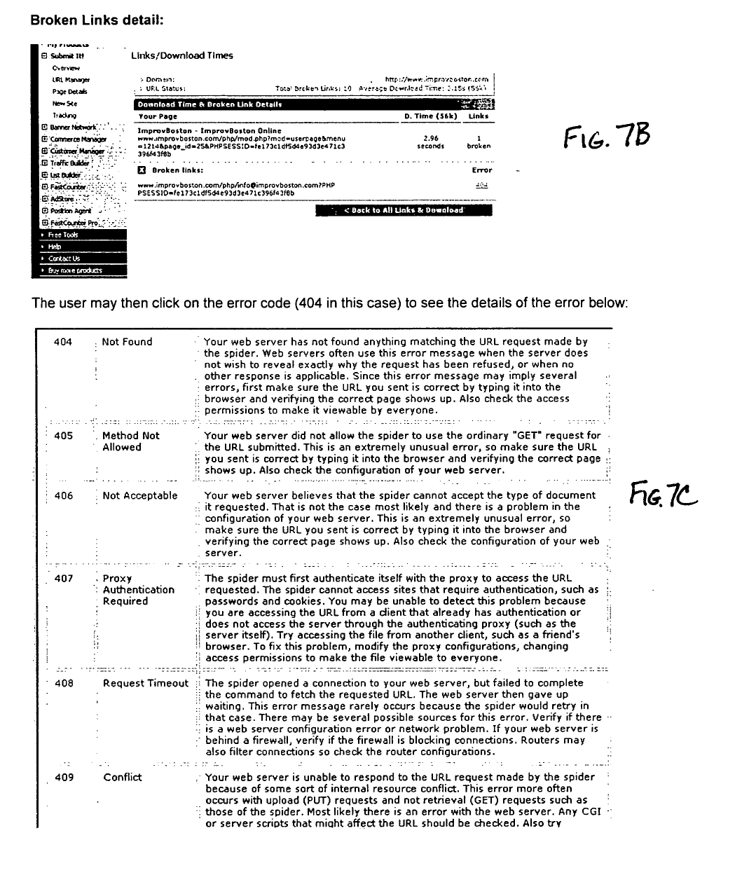

When the user clicks each of those items shown in FIG. 6, additional detailed information is shown. For example, FIG. 7A illustrates one illustrative embodiment of a screen shot that appears when a user clicks on the “broken links” information item in FIG. 6. The complete list of broken links can be shown, or it can be abbreviated.

The user can then select one of the broken links shown in FIG. 7A and select the “view link details” button. In that case, additional information will be displayed with respect to that link, such as the information shown in the illustrative screen shot set out in FIG. 7B. That information includes such things as the identification of the broken link and an error code associated with that link. By selecting the error code, additional information relating to the displayed error code will be provided, such as shown in the screen shot illustrated by FIG. 7C. Of course, the broken links information can be provided in a number of different forms and that shown in FIGS. 7A-7C is but one illustrative way to present the information.

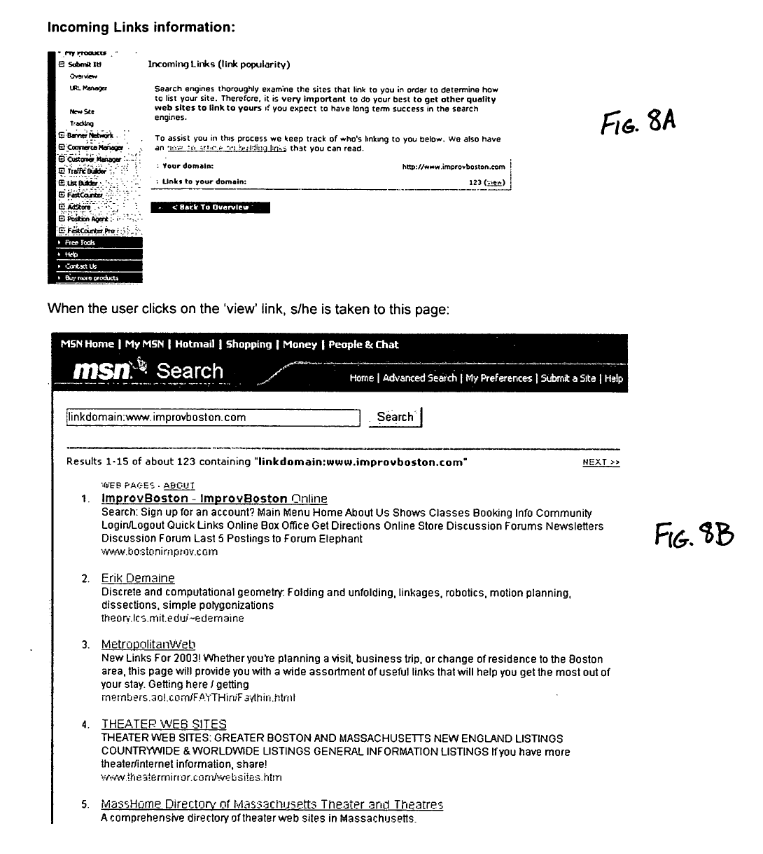

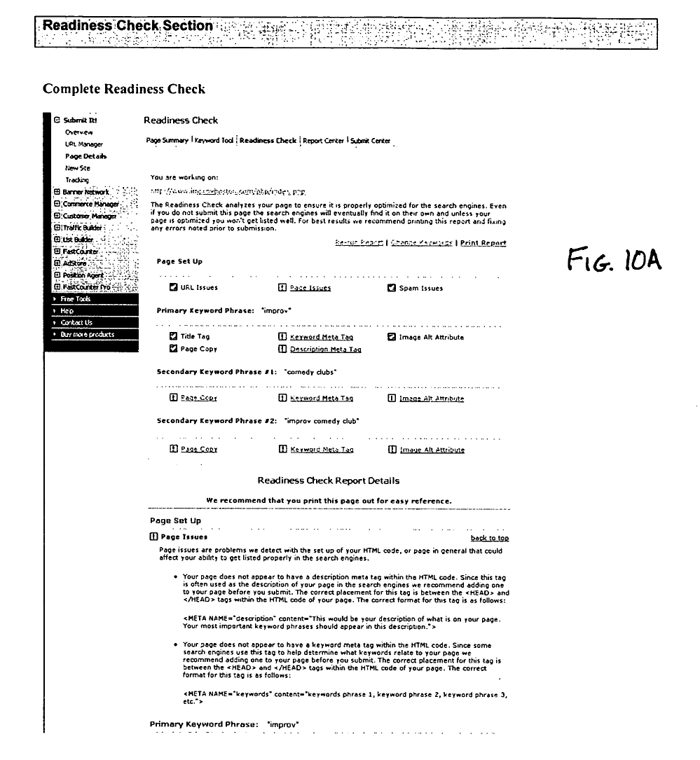

The reports provided by component 202 can also include a report of incoming links or those web pages which have links to the present web site under consideration. One illustrative screen shot for showing this information is shown in FIG. 8A. If the user elects the “view” input in FIG. 8A, the web sites which contain links to the web site under consideration are shown. One illustrative screen shot for showing this information is shown in FIG. 8B.

The reports output by component 202 can also include a download time report. Such a report can include such information as how long it takes the page to load. One illustrative screenshot for showing this information is set out in FIG. 9.

Component 202 will also illustratively output a readiness check report. Such a report will illustratively be provided for each page 214 of the web site under consideration. The readiness check report will include information that indicates how effectively the page will be used by search engines. In other words, the information will give the user an indication as to how likely it is that any of the user's web pages 214 will be ranked high in the list of search results returned by a search engine using the keywords selected.

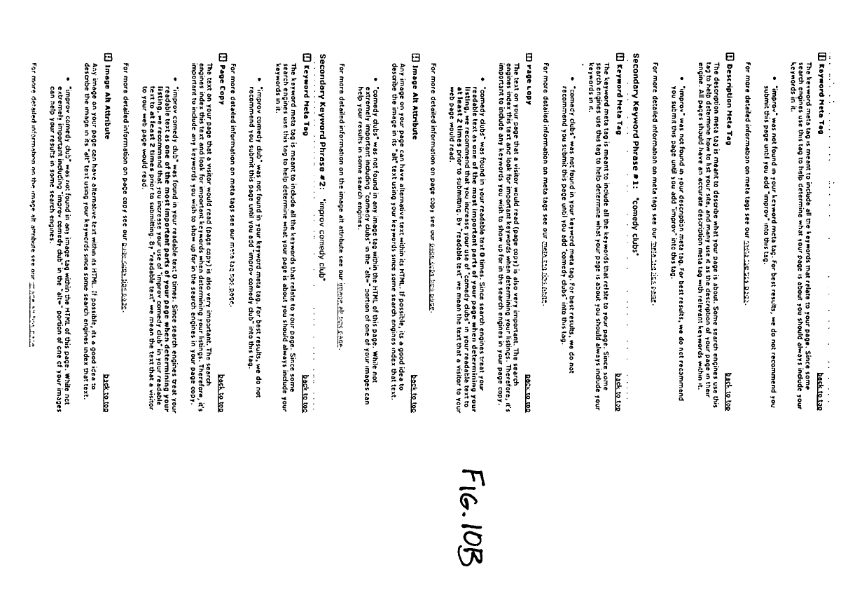

In one illustrative embodiment, component 202 not only outputs a report indicating problems with an associated web page, but also outputs suggested actions which can be taken to remedy or reduce the problems. FIGS. 10A and 10B are screen shots illustrating one embodiment of such a readiness report. It can be seen in FIG. 10A that component 202 flags problems associated with such things as the page setup, and the searchability of the page with respect to the primary keywords and the other keywords selected by the user. Recall that the rules applied when scrutinizing the information on a content page 214 may differ based on whether the key word being used to scrutinize the page is a primary or secondary keyword.

In any case, the boxes associated with each of the areas of scrutinization shown in FIG. 10A can illustratively be provided with a marker indicative of whether those issues turned out to be a problem. For instance, it can be seen that both “URL issues” and “spam” issues have a check mark adjacent them. This indicates that the site has passed the check for those particular items. However, the “page issues” item has an exclamation point next to it. This indicates that the check found a minor problem with the URL for that particular item. Another indicator, such as an “x” can be used to indicate that the URL has a serious problem with a particular item, which could greatly affect the success of the URLs submission to a search engine.

By clicking on any of the issues listed in FIG. 10A, the user is shown to an explanation of the issues found, and illustratively a suggestion as to how to address the problem. A number of these descriptions and suggestions are shown at the bottom half of FIG. 10A and in FIG. 10B. For example, the “page issues” are described as problems detected with the setup of the HTML code, or page in general, that could effect the ability to obtain listing in a search engine. Then, the specific problems found are discussed. One such problem shown in FIG. 10B is that the page does not appear to have a description meta tag within the HTML code. The description then goes on to suggest a fix for that problem, and even provide the correct format for such a tag. Additional examples of issues which are found by the analysis performed by component 202 and reported to the user are shown in FIG. 10B. Again, of course, this information can be provided to the user in a number of different ways and that shown in FIGS. 10A and 10B is illustrative only. Also, additional or different issues can be the subject of the scrutiny and analysis in component 202, and those listed in FIG. 10A are illustrative only.

It can thus be seen that the present invention provides a component which can be used by a network content provider to select keywords to be identified in the content. The present invention can also be used to scrutinize a content provider's web pages to determine how effective they will be when subjected to searches by conventional search engines. Similarly, the present invention can be used to identify problems that may arise in attempting to get a web site or web pages listed at, and indexed by, search engines.

Although the present invention has been described with reference to particular embodiments, workers skilled in the art will recognize that changes may be made in form and detail without departing from the spirit and scope of the invention.

1. A computer implemented method of processing content to determine whether the content includes attributes that inhibit desired indexing by a search engine, comprising:
receiving at least one key word;
analyzing information in a content page to determine whether the key word is used in one of a predetermined plurality of ways in the information, such that the search engine will index the content page in a desired way, based on the key word; and
generating a report indicative of whether the key word is used in the predefined plurality of ways.

2. The computer implemented method of claim 1 wherein analyzing comprises:
determining whether the key word is used in such a way that the search engine will determine that the key word is related to the content page

3. The computer implemented method of claim 1 wherein analyzing information in a content page comprises:
analyzing the information to identify whether the key word is used in the information in such a way as to cause the search engine to determine that the key word is related to the content page at a threshold level.

4. The computer implemented method of claim 3 wherein analyzing the information in the content page comprises:
analyzing the information to identify one or more of the predetermined ways that the key word can be used in the information to cause the search engine to determine that the key word is related to the content page at an increased level.

5. The computer implemented method of claim 2 wherein generating a report comprises:
generating suggested information manipulations for the information on the content page based on one or more predetermined ways the key word can be used.

6. The computer implemented method of claim 1 wherein analyzing comprises:
accessing rules regarding how key words are used in the predetermined plurality of ways; and
applying the rules to information on the content page.

7. The computer implemented method of claim 1 wherein receiving at least one key word comprises:
receiving a plurality of key words.

8. The computer implemented method of claim 7 wherein analyzing comprises:
analyzing the information in the content page to determine whether each of the plurality of key words is used in one of a predetermined plurality of ways in the information, such that the search engine will determine that each of the plurality of key words is related to the content page

9. The computer implemented method of claim 8 wherein generating a report comprises:
generating the report indicative of whether each of the plurality of key words is used in the predefined plurality of ways.

10. The computer implemented method of claim 1 and further comprising:
analyzing format information on the content page to determine whether the content page is formatted properly for the search engine.

11. The computer implemented method of claim 1 and further comprising:
analyzing a content site that corresponds to a plurality of content pages to determine whether the content site includes information that will inhibit desired operation of the search engine.

12. The computer implemented method of claim 1 wherein receiving the key word comprises:
receiving an initial set of key words from the user.

13. The computer implemented method of claim 12 wherein receiving the key word comprises:
accessing at least one search engine to identify alternative key words based on the initial set of key words.

14. The computer implemented method of claim 13 wherein receiving the key word comprises:
receiving a user selection of a first subset of the initial set of key words.

15. The computer implemented method of claim 14 wherein receiving the key word comprises:
ranking the first subset of key words based on a statistical effectiveness measure indicative of how effective the key words in the first subset are in uniquely identifying the content page as against other content pages accessible through the network.

16. The computer implemented method of claim 15 wherein receiving the key word comprises:
receiving a user selection of a second subset of the key words from the ranked first subset.

17. The computer implemented method of claim 16 wherein receiving the key word comprises:
receiving a user indication of a primary key word in the second subset.

18. The computer implemented method of claim 17 wherein analyzing comprises:
accessing a set of rules for application to the information on the content page; and
applying the rules to the information for each of the second subset of key words, based on the user indication of the primary key word.

19. A system for determining whether a content page includes attributes that will inhibit desired indexing by a search engine, comprising:
a rule store storing rules used to identify the attributes;
a keyword generator configured to receive an initial keyword as a user input and access search engine information and provide one or more additional keywords; and
a crawler configured to identify the attributes in the content page based on the one or more additional keywords and the rules.

20. The system of claim 19 wherein the crawler is configured to identify the attributes based on the initial keywords.

21. The system of claim 19 and further comprising:
a report component configured to generate a report indicative of the attributes.

22. The system of claim 21 wherein the report component is configured to output suggested manipulations to eliminate the attributes.

23. The system of claim 22 wherein the report component is configured to determine whether selected ones of the one or more additional keywords are used in such a way that the search engine will determine that the selected keywords are related to the content page.

24. The system of claim 21 wherein the report component is configured to access rules regarding how a keyword is used in such a way that the search engine will determine that the content page is related to the keyword, and to apply the rules to information on the content page.

25. The system of claim 21 wherein the one or more additional keywords comprise a plurality of additional keywords, and wherein the report component is configured to analyze information in the content page to determine whether each of the plurality of additional keywords is used in one of a predetermined plurality of ways in the information, such that the search engine will determine that each of the plurality of additional keywords is related to the content page

26. The system of claim 25 wherein the report component is configured to generate the report indicative of whether each of the plurality of additional keywords is used in the predefined plurality of ways.

27. The system of claim 21 wherein the report component is configured to analyze format information on the content page to determine whether the content page is formatted properly for the search engine.

28. The system of claim 21 wherein the keyword generator is configured to access at least one search engine, based on the user input initial keyword and to identify an initial set of keywords based on the user input initial keyword and the search engine information.

29. The system of claim 28 wherein the keyword generator is configured to receive a user selection of a first subset of the initial set of keywords.

30. The system of claim 29 wherein the keyword generator is configured to rank the first subset of keywords based on a statistical effectiveness measure indicative of how effective the keywords in the first subset are in uniquely identifying the content page as against other content pages accessible through a network.

31. The system of claim 30 wherein the keyword generator is configured to receive a user selection of a second subset of the key words from the ranked first subset.

32. The system of claim 31 wherein the keyword generator is configured to receive a user indication of a primary key word in the second subset.

33. The system of claim 32 the report component is configured to access a set of rules for application to the information on the content page, and apply the rules to the information for each of the second subset of key words, based on the user indication of the primary key word.
